(19) United States
(12) Patent Application Publication
(10) Pub. No.: US 2024/0246188 A1
(43) Pub. Date: Jul. 25, 2024

(54) CHAMFER TOUCH-OFF TOOL

(71) Applicant: Duane Aiken, Rosman, NC (US)

(72) Inventor: Duane Aiken, Rosman, NC (US)

(21) Appl. No.: 18/415,443

(22) Filed: Jan. 17, 2024

Related U.S. Application Data
(60) Provisional application No. 63/441,063, filed on Jan. 25, 2023.

(51) Int. Cl. B23Q 17/22

(52) U.S. Cl. CPC B23Q 17/2233

(57) ABSTRACT

A touch-off device includes a control diameter for calibrating non-cylindrical chamfering tools.

### CROSS-REFERENCE TO RELATED APPLICATIONS

This utility patent application claims benefit of U.S. Provisional Patent Application Ser. No. 63/441,063 filed in the United States patent and Trademark Office on Jan. 25, 2023, which is incorporated herein by reference thereto in its entirety.

### BACKGROUND OF THE DISCLOSURE

In the precision machining industry cutting tools are used to remove material to craft components. For example, in milling operations a workpiece is fixed in place on a machine table, and a cutting tool rotates in a spindle to remove material from the workpiece. The process may be manual whereby a craftsman employs a simple machine with dials to control machine movements, or the process may utilize Computer Numerical Controls (“CNC”) in which the machine movements are computer guided. In either case cutting tools must be calibrated or “touched off” with the workpiece. Many touch-off techniques are used ranging from utilizing a simple piece of paper to electronic probes. However, known techniques are only suitable for flat-ended cutting tools and do not translate well to chamfering tools with beveled cutting edges.

Although accessory devices exist for calibrating cylindrical tools and some machine tools employ electronic probes, no device or method exists for efficiently calibrating cutting tools that have beveled, conical, or non-flat cutting edges, i.e., chamfering tools. For example, using known processes and devices, a machinist must take tedious measurements, make extensive calculations, and make test cuts to employ chamfering tools, which may still result in errors, wasted time and materials, and extra expense. Accordingly, calibrating chamfering tools presents a difficult challenge for manual and CNC machinists alike.

What is needed in the precision machining industry are devices and methods for calibrating chamfer cutting tools quickly and efficiently.

### BRIEF SUMMARY OF THE DISCLOSURE

The present disclosure is directed in general to devices for quickly and efficiently calibrating chamfer cutting tools. While these devices are useful in manual milling processes, they are particularly beneficial in CNC milling applications where the impact of errors may be more consequential.

In one embodiment according to the disclosure, an interchangeable contact element for a touch-off gauge may include a body having a proximal end and a distal end, the proximal end being connectable within a touch-off gauge housing, the distal end having a control diameter formed therein, the control diameter being complementary to a conical chamfering tool.

In another embodiment, a chamfering tool calibration system may include a touch-off device having a distal end and a proximal end, the distal end defining an aperture therein, the proximal end including a spring attached thereto; and a calibration housing having a cavity defined therein, the touch-off device being insertable in the cavity and connectable therein by the spring, the aperture facing in an outward direction to define a control diameter; wherein a tip of a cutting tool is placed in the aperture, the tip being seated at least partly through the aperture as limited by the control diameter to ascertain width and height of the cutting tool to formulate a chamfering tool path.

In a further embodiment, a method of employing an interchangeable contact element may include installing a contact element with a desired control diameter formed therein in a calibration device; placing the calibration device on a workpiece, the calibration device having a dial; lowering a tip of a conical chamfering tool into the control diameter of the contact element; continuing to lower the conical chamfering tool to permit the calibration device to center itself on the conical chamfering tool; adjusting a height of the conical chamfering tool height until the dial reads is zeroized; touching the tool calibration command on the controller of the machine tool; deducting a height of the calibration device from a value determined by a controller; inputting the new value; raising the conical chamfering tool; removing the calibration device from the workpiece; and using the conical chamfering tool to form the workpiece.

The method may also include establishing a toolpath for the conical chamfering tool and/or inputting the control diameter as the tool diameter and/or inputting a depth of cut to perform a desired “Z” depth chamfer.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a top perspective view of an exemplary touch-off device installed in a calibration system according to the disclosure, particularly showing a chamfer cutting tool being touched off in an intended use environment, partially shown for clarity;

FIG. 2A shows a front elevational view of the chamfer cutting tool relative to the calibration system and touch-off device as in FIG. 1;

FIG. 2B is a side elevational and sectional view taken along line 2B-2B in FIG. 2A, particularly showing the touch-off device installed in a housing of the calibration system with a chamfer tool in phantom for clarity;

FIG. 3 is partial sectional and elevational view of the embodiment as in FIG. 2A, particularly showing the chamfer cutting tool relative to a control diameter of the touch-off device according to an aspect of the disclosure;

FIG. 4A is a schematic plan view of a chamfer cutting tool as in FIG. 3 tracking a toolpath pattern without offset, particularly showing an intrusion area of the chamfer cutting tool prior to calibration with the touch-off device;

FIG. 4B is a schematic plan view of a chamfer cutting tool as in FIG. 3 tracking a toolpath pattern with offset after calibration with the touch-off device;

FIG. 5 is a perspective view of the calibrated chamfering tool as in FIG. 4B relative to a workpiece;

FIG. 6 is top perspective view of the embodiment as in FIG. 2A, particularly showing the touch-off device being removed (or installed) in the calibration system with a nearby selection other touch-off devices having varying control diameters to accommodate different sizes of chamfering tools; and

FIG. 7 is top perspective view of the calibration system as in FIG. 6, particularly showing the touch-off device installed in a housing of the calibration system.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but as bases for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrases “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, et cetera. Thus, for example, “a device having components a, b, and c” means that the device includes at least components a, b, and c. Similarly, the phrase: “a method involving a, b, and c” means that the method includes at least steps a, b, and c.

Where a list of alternative component terms is used, e.g., “a structure such as ‘a,’ ‘b,’ ‘c,’ ‘d,’ or the like,” or “a” or b,” such lists and alternative terms provide meaning and context for the sake of illustration, unless indicated otherwise. Also, relative terms such as “first,” “second,” “third,” “left,” “right,” “front,” “rear,” et cetera are intended to identify or distinguish one component or feature from another similar component or feature, unless indicated otherwise herein.

When a list of element names are provided with a component or step element number, the names are understood as identifying, nonlimiting, alternative nomenclature for that component or step; e.g., “bird, poultry, or fowl 10” means element number 10 may mean and be referred to by any of the listed nomenclature.

The various embodiments of the disclosure and/or equivalents falling within the scope of the present disclosure overcome or ameliorate at least one of the disadvantages of the prior art.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

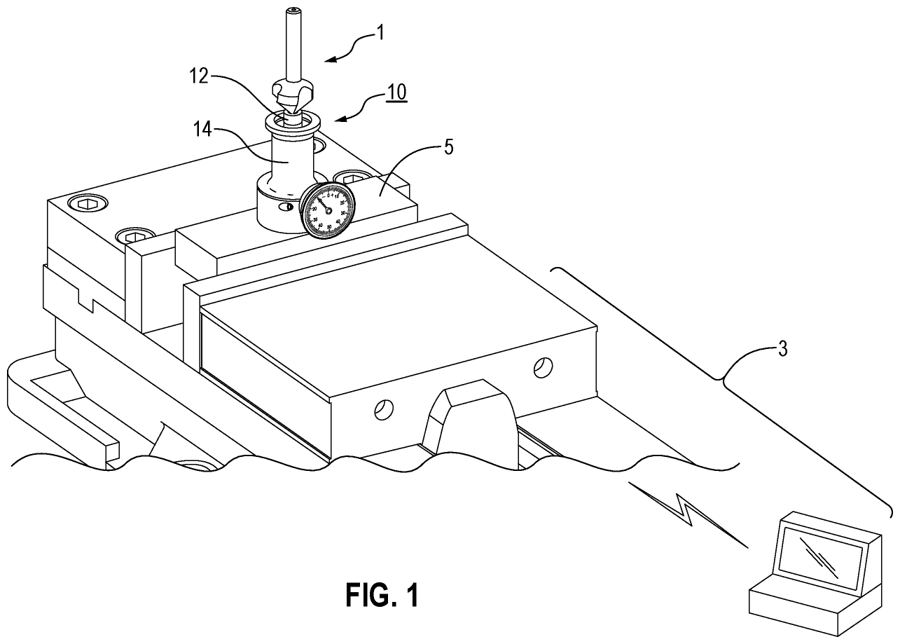

Turning now to FIG. 1, an exemplary chamfer tool calibration system is designated in general by element number 10. The calibration system 10 broadly includes an interchangeable “touch-off device,” plunger, or contact element 12 installed in a calibration housing 14. As will be explained in detail below, the touch-off device 12 is used to calibrate a chamfer or cutting tool 1 having beveled, flared, conical, or non-cylindrical cutting edges, ends, or teeth as shown here in exemplary use on a chamfer table and control system 3, which may also be referred to herein as the cutting table and controller. Here, the manual or CNC controller is schematically shown in electronic or wireless communication with the cutting table of the system 3. Once the chamfering tool 1 is calibrated, a workpiece 5 can be chamfered quickly and efficiently using the cutting table of the system 3.

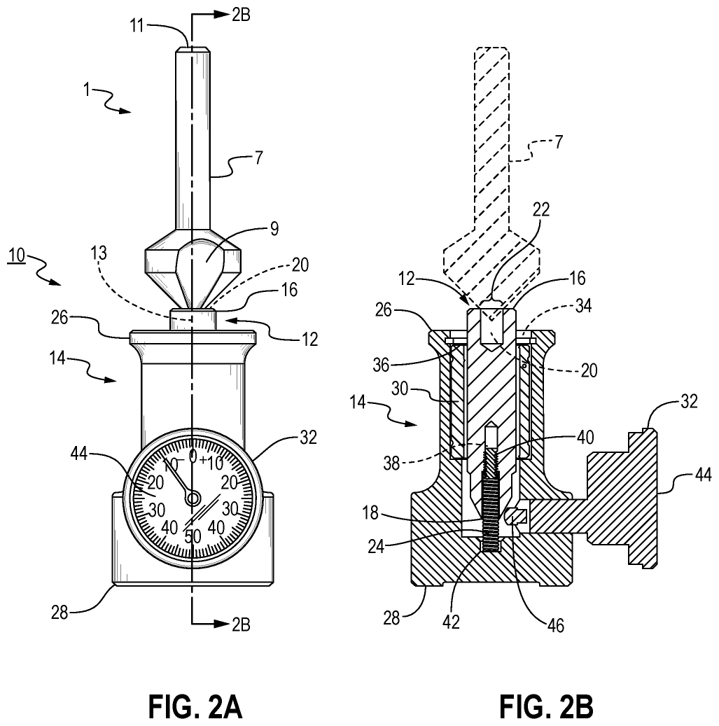

FIGS. 2A and 2B show the exemplary chamfer tool calibration system 10 introduced above in which the touch-off device 12 is installed in the calibration housing 14 for calibrating the cutting tool 1. In this example, the cutting tool 1 has a rod, neck, or shank 7 from which irregularly shaped or non-flat cutting teeth 9 extend. A centerline, vertical axis, or cutter center 11 runs through the shank 7 of the cutting tool 1 to its end or tip 13, which, as shown, extends at least partially into an aperture 20 of a top, first end, or distal end 16 of the touch-off device 12.

FIG. 2B shows the calibration system 10 segmented with the cutting tool 1 shown in phantom for clarity. Here, the exemplary touch-off device 12 is further shown to include a bottom, second end, or proximal end 18 and a control diameter 22 defining the aperture 20. More particularly, the cutting tool tip 13 seats partly in the aperture 20, i.e., to a depth as limited by the control diameter 22. Further, a spring 24 is attached to the proximal end 18, which is shown inserted in the calibration housing 14 and by interoperation of these components, the cutting tool 1 is calibrated as explained below.

With continued reference to FIGS. 2A and 2B, the calibration housing 14 includes a distal end or top 26 and a proximal end or base 28. A linear guide bearing 30 is installed in the housing 14 for receiving the touch-off device 12, and a graduated height monitoring device 32 is in communication with the proximal end 18 of the touch-off device 12 when seated in a cavity 34 of the housing 14. The device 32 is used in the exemplary calibration process described below. Also shown, the linear guide bearing 30 may include a snap-ring 36 to align and position the distal end 16 of the touch-off device 12 when installed in the cavity 34.

FIG. 2B particularly shows a hole or receptacle 38 in the touch-off device 12 that may hold a set screw 40 for connecting the spring 24 at the proximal end 18 of the touch-off device 12. A spring receptacle 42 is formed in the housing 14 for receiving the spring 24 in which the connected spring 24 compresses under a spring constant when the cutting tool 7 is pressed against the touch-off device 12 for compliance. In this regard, the graduated height monitoring device 32 introduced above may include a dial or gauge 44, which is used by a craftsman to “zero out” a height of the cutting tool 1. Here, a pressure or contact element 46 is in communication with the proximal end 18 of the touch-off device 12 and the gauge 44 to ascertain and set a chamfer tool height by displacing the contact element 46 until the gauge 44 reads zero. More particularly, as a technician presses the tip 13 of the cutting tool 1 into the aperture 20 of the touch-off device 12, the spring 24 is compressed and the proximal end 18 contacts the element 46 until “zero” is displayed on the gauge 44 at which point the technician can take calibration measurements to account for the non-cylindrical character of the cutting tool 1.

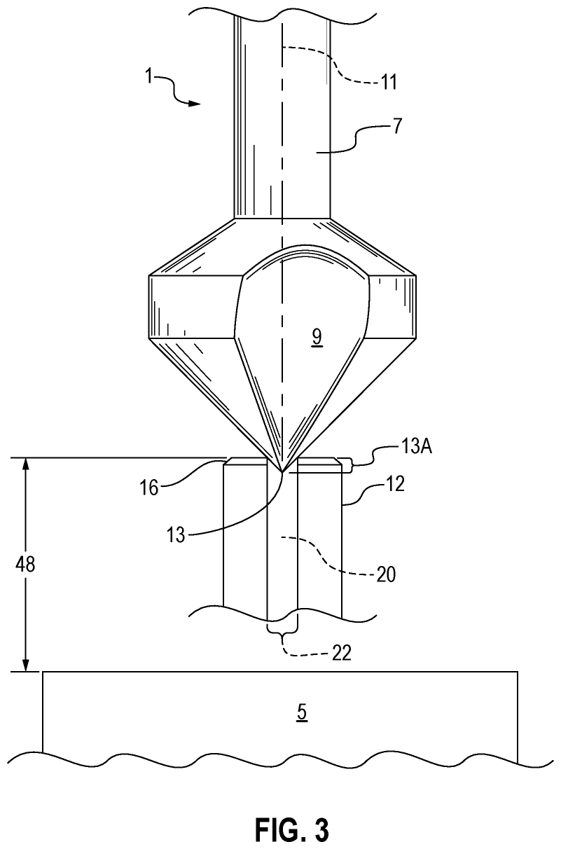

With reference now to FIG. 3, the non-cylindrical cutting tool 1 is shown in detail with cutting teeth 9 extending from the shank 7 with the centerline 11 running through the cutting tool 1 to its tip 13. As introduced above, the tip 13 projects partially into the aperture 20 of the distal end 16 of the touch-off device 12 (shown partially relative to the workpiece 5 for clarity), the insertion depth of the tip 13 being dependent upon a size of the control diameter 22 of the aperture 20. When the touch-off device 12 is placed in the calibration housing 14 as described above with respect to FIG. 2B, a set height 48 can be determined. As shown in FIG. 3, the set height 48 includes a portion or length 13A of the tip 13, which is determined by a size of the aperture 20, i.e., the larger the aperture 20, the greater the height 13A as the tip 13 will extend farther into the aperture 20, and vice versa.

With reference to FIGS. 1, 2A, 2B, and 3, setup and programming of the calibration system 10 according to an aspect of the disclosure may include the following:

### Setup

1. Choose the touch off contact element 12 with a desired control diameter 22 and install the touch off device 12 in the calibration housing 14 of the calibration device 10.
2. Place the calibration device 10 on a target workpiece 5.
3. Lower the tip 13 of the cutter 1 into the aperture 20 of the contact element 12.
4. Continue to lower the cutter 1 to permit the device 12 to center itself on the cutter 1.
5. Adjust the cutter height until the gauge 44 reads ZERO on the height monitoring device 32.
6. Touch the tool calibration command on a controller of the machine tool 3.
7. Deduct, e.g., three (3) inches from a determined value and input the new value in the controller 3.
8. Raise the cutter 1 and remove the calibration device 14 from the workpiece 5.

### Programming

1. Establish a toolpath for the chamfer cutter 1.
2. Input the “Control Diameter” as the tool diameter in the controller 3.
3. Input the depth of cut in the controller 3 to perform the desired chamfer's “Z” depth (relative to X-Y-Z axes).

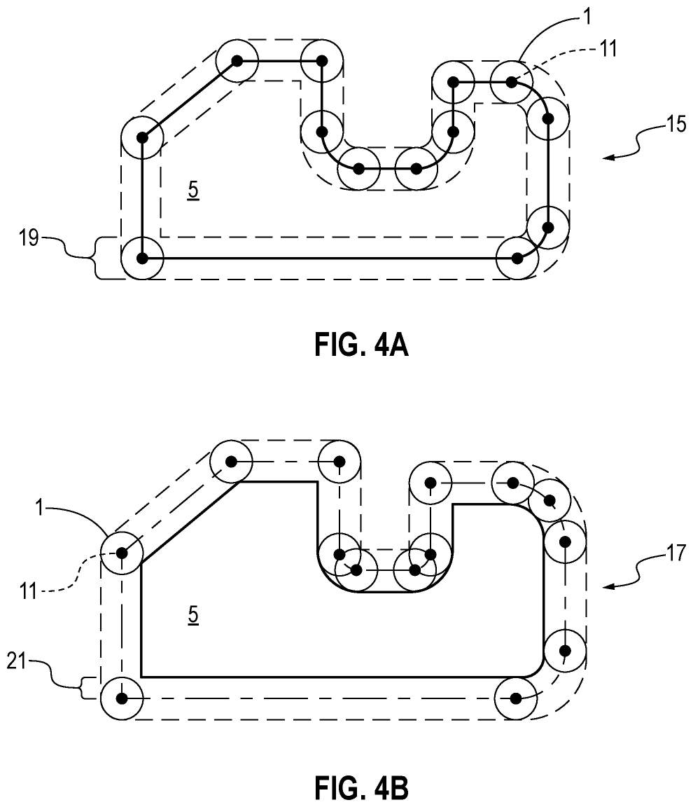

FIGS. 4A and 4B show that CNC machine tools can cut large features using relatively small tools via X-Y-Z movements along a machine's axes. FIG. 4A particularly shows a workpiece 5 being cut by a tool 1 having a center 11. However, a calibrated tool path has not been ascertained and applied, which results in a “No Offset” application 15 having an intrusion area or miscut 19.

FIG. 4B shows a tool path “With Offset” 17 that has been formulated by ascertaining a tool diameter (which becomes the machine offset) using the calibration device 14 equipped with the touch-off device 12 and a determined cutting depth. This is relatively simple with cylindrical cutting tools having uniform circumferences—a diameter of a cutter can easily be measured and its flat end can be touched onto the workpiece or other device. Conical cutters and their associated machining operations may be approached by the same methods if the tool diameter (or control diameter) at a specific height from the workpiece is known, which the present disclosure provides. More specifically, by contacting a cutter 1 directly on the bevel 9 by an element of known size and known height, the missing values are quickly available to calibrate the cutter 1.

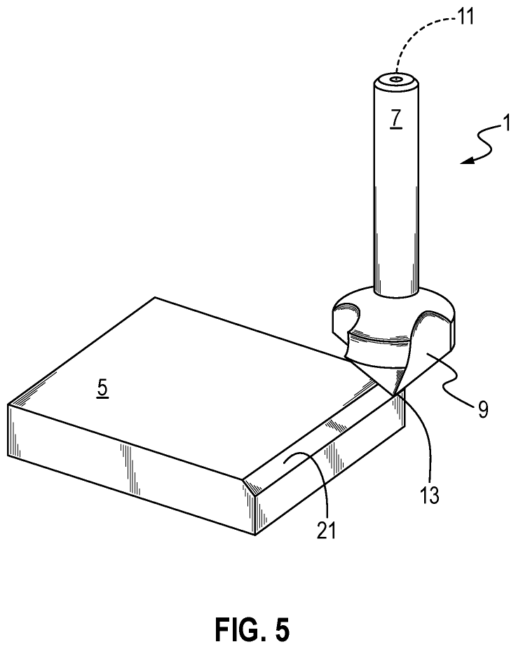

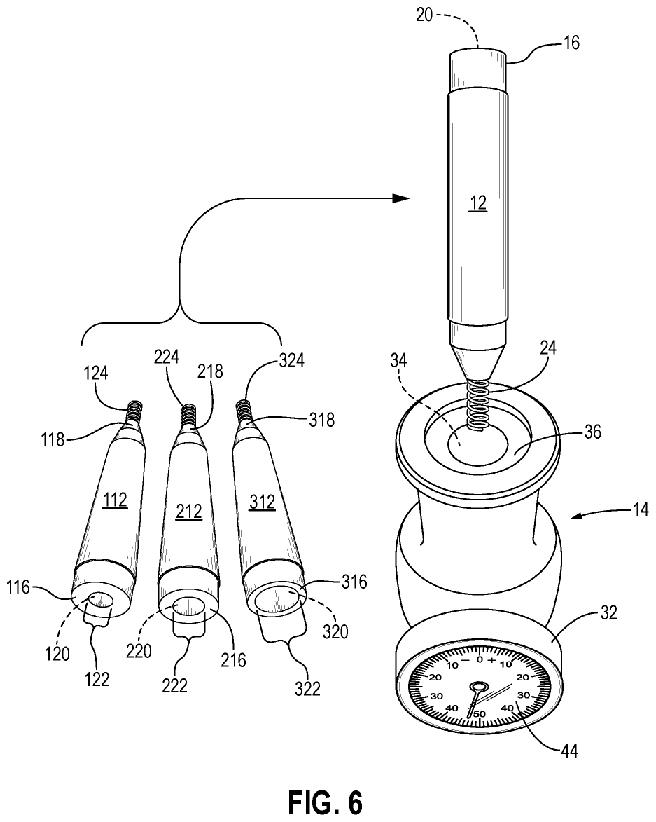

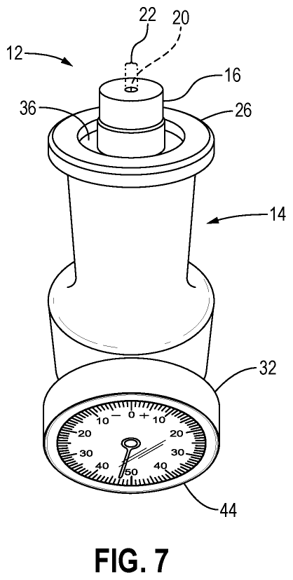

Turning now to FIGS. 5, 6 and 7, it is often desirable to use different segments or teeth 9 of the cutting tool 1. This could be necessitated by cutter shapes, preferred machining conditions, or interference with unused portions of a cutter with other features on the workpiece. Therefore, the devices of the disclosure offer interchangeable contact elements 12 having an array of control diameters. More particularly, FIGS. 6 and 7 show an exemplary installation (or removal) operation in which a touch-off device 12 is being installed in (or removed from) the calibration housing 14. Here, the linear guide bearing 30 (see FIG. 2B) and the snap-ring 36 guide and position the device 12 and its spring 24 at the proximal end 18 through the cavity 34 of the housing 14. The graduated height monitoring device 32 introduced above includes the gauge 44, which is used to “zero out” a height of the cutting tool 1 (see FIG. 5) utilizing the aperture 20 and diameter 22 of the distal end 16.

FIG. 6 further shows variations of touch-off devices 112, 212, 312 each having respective distal ends 116, 216, 316 having respective apertures 120, 220, 320 and control diameters 122, 222, 322, and respective proximal ends 118, 218, 218 with respective springs 124, 224, 324. The various control diameters 122, 222, 322 (and others) can be selected to ascertain widths and heights of a variety of cutting instruments.

Exemplary embodiments as disclosed herein may include but are not limited to:

### Embodiment 1

An interchangeable contact element for a touch-off gauge, comprising a body having a proximal end and a distal end, the proximal end being connectable within a touch-off gauge housing, the distal end having a control diameter formed therein, the control diameter being complementary to a conical chamfering tool.

### Embodiment 2

A method of employing the interchangeable contact element as in embodiment 1, comprising installing a contact element with a desired control diameter formed therein in a calibration device; placing the calibration device on a workpiece, the calibration device having a dial; lowering a tip of a conical chamfering tool into the control diameter of the contact element; continuing to lower the conical chamfering tool to permit the calibration device to center itself on the conical chamfering tool; adjusting a height of the conical chamfering tool height until the dial reads is zeroized; touching the tool calibration command on the controller of the machine tool; deducting a height of the calibration device from a value determined by a controller; inputting the new value; raising the conical chamfering tool; removing the calibration device from the workpiece; and using the conical chamfering tool to form the workpiece.

### Embodiment 3

The method as in embodiment 3, further comprising establishing a toolpath for the conical chamfering tool.

### Embodiment 4

The method as in embodiments 2 or 3, further comprising inputting the control diameter as the tool diameter.

### Embodiment 5

The method as in any of the embodiments 2, 3, and 4, further comprising inputting a depth of cut to perform a desired “Z” depth chamfer.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A chamfering tool calibration system, comprising:
a touch-off device having a distal end and a proximal end, the distal end defining an aperture therein, the proximal end including a spring attached thereto; and
a calibration housing having a cavity defined therein, the touch-off device being insertable in the cavity for compressing the spring, the aperture facing in an outward direction to define a control diameter;
wherein a tip of a cutting tool is placed in the aperture, the tip being seated at least partly through the aperture as limited by the control diameter to ascertain width and height of the cutting tool to calibrate the cutting tool and formulate a chamfering tool path.

2. The chamfering tool calibration system as in claim 1, wherein the aperture is disposed apart from the cavity.

3. The chamfering tool calibration system as in claim 1, further comprising a linear guide bearing disposed in the calibration housing for receiving the touch-off device.

4. The chamfering tool calibration system as in claim 1, further comprising a height monitoring device in communication with the proximal end of the touch-off device.

5. An interchangeable contact element for a touch-off gauge, comprising:
a body having a proximal end and a distal end;
a spring connected to the proximal end and being connectable within a touch-off gauge housing; and
the distal end having a control diameter formed therein, the control diameter being configured to receive a portion of a chamfering tool to ascertain width and height of the chamfering tool.

6. A method of employing an interchangeable touch-off device, comprising:
installing in a calibration device a touch-off device having a contact element defining a control diameter formed therein;
placing the calibration device on a workpiece on a machining tool, the calibration device including a dial;
lowering a tip of a chamfering tool into the control diameter of the contact element;
continuing to lower the conical chamfering tool until the calibration device is centered on the chamfering tool;
adjusting a height of the chamfering tool until the dial reads zero;
touching the tool calibration command on a controller of the machining tool;
deducting a height of the calibration device from a value determined by the controller to produce a new value;
inputting the new value;
raising the chamfering tool;
removing the calibration device from the workpiece; and
using the calibrated chamfering tool to chamfer the workpiece.

7. The method as in claim 6, further comprising establishing a toolpath for the chamfering tool.

8. The method as in claim 6, further comprising inputting the control diameter as the tool diameter.

9. The method as in claim 6, further comprising inputting a depth of cut to perform a Z-depth chamfer.
